(19) United States
(12) Patent Application Publication
(10) Pub. No.: US 2026/0065903 A1
(43) Pub. Date: Mar. 5, 2026

(54) Computational Latencies Of End-To-End Models By Large Reduction Of The Number Of Encoder Output Frames

(71) Applicant: Google LLC, Mountain View, CA (US)

(72) Inventors: Rohit Prakash Prabhavalkar, Santa Clara, CA (US); Zhong Meng, Mountain View, CA (US); Weiran Wang, Iowa City, IA (US); Adam Michael Stooke, San Francisco, CA (US); Xingyu Cai, Mountain View, CA (US); Yanzhang He, Mountain View, CA (US); Arun Narayanan, Milpitas, CA (US); Tara N. Sainath, Jersey City, NJ (US); Pedro J. Moreno Mengibar, Jersey City, NJ (US); Dongseong Hwang, Mountain View, CA (US)

(73) Assignee: Google LLC, Mountain View, CA (US)

(21) Appl. No.: 18/820,915

(22) Filed: Aug. 30, 2024

Related U.S. Application Data
(60) Provisional application No. 63/580,855, filed on Sep. 6, 2023.

(51) Int. Cl. G10L 15/16; G10L 15/18

(52) U.S. Cl. CPC G10L 15/16; G10L 15/18

(57) ABSTRACT

A method includes receiving a sequence of encoder input frames as input to an end-to-end model. The method also includes generating a sequence of encoder output frames based on the sequence of encoder input frames using an encoder of the end-to-end model. The encoder includes a stack of multi-head attention blocks arranged to apply an encoder reduction ratio on the sequence of encoder input frames. A number of encoder output frames generated as output from the encoder is reduced from a number of the encoder input frames received as input to the encoder by a factor proportional to the encoder reduction ratio applied by the stack of multi-head attention blocks. The method also includes decoding the sequence of encoder output frames into a sequence of output tokens using a decoder of the end-to-end model.

### CROSS REFERENCE TO RELATED APPLICATIONS

This U.S. patent application claims priority under 35 U.S.C. § 119(e) to U.S. Provisional Application 63/580,855, filed on Sep. 6, 2023. The disclosure of this prior application is considered part of the disclosure of this application and is hereby incorporated by reference in its entirety.

### TECHNICAL FIELD

This disclosure relates to computational latencies of end-to-end models by large reduction of the number of encoder output frames.

### BACKGROUND

End-to-end automatic speech recognition (ASR) models have become increasingly popular in recent years. As performance of the ASR models has increased, so has the number of parameters of the ASR models with some ASR models having billions of parameters. The larger ASR models, coupled with full-sequence processing of input audio, has enabled significant improvements in word error rates (WER) at a cost of much higher computational latency. High-latency processing may be acceptable in some speech recognition tasks (e.g., offline video captioning) while other speech recognition tasks (e.g., recognizing short voice search queries) require low-latency processing. As such, speech recognition tasks that require low-latency processing cannot benefit from the large, full-sequence ASR models unless the computational latency associated with operating these models significantly reduces.

### SUMMARY

One aspect of the disclosure provides an end-to-end model. The end-to-end model includes an encoder that has a stack of multi-head attention blocks arranged to apply an encoder reduction ratio on encoder input frames. The encoder is configured to receive a sequence of encoder frames as input and generate a sequence of encoder output frames as output. Here, a number of the encoder output frames generated as output from the encoder is reduced from a number of the encoder input frames received as input to the encoder by a factor proportional to the encoder reduction ratio applied by the stack of multi-head attention blocks. The end-to-end model also includes a decoder configured to decode the sequence of encoder output frames into a sequence of output tokens.

Implementations of the disclosure may include one or more of the following optional features. In some implementations, the end-to-end model includes an end-to-end automated speech recognition (ASR) model, the encoder includes an audio encoder, the encoder input frames include acoustic feature frames characterizing a spoken utterance, and the sequence of output tokens characterize a transcription of the utterance. Here, the output tokens include wordpieces. In these implementations, the output tokens may include graphemes, phonemes, or words.

In some examples, the decoder includes: a prediction network configured to, at each of a plurality of output steps, receive, as input, a sequence of previous non-blank symbols output by a final softmax layer and generate a hidden representation; and a joint network configured to receive, as input, the hidden representation generated by the prediction network at each of the plurality of output steps and each encoder output frame in the sequence of encoder output frames generated by the encoder and generate, at each of the plurality of output steps, a probability distribution over possible output tokens. In these examples, at each of the plurality of output steps: the sequence of previous non-blank symbols received as input at the prediction network includes a sequence of N previous non-blank symbols output by the final softmax layer; and the prediction network is configured to generate the hidden representation by generating a respective embedding for each non-blank symbol of the sequence of N previous non-blank symbols and generating an average embedding by averaging the respective embeddings with the average embedding including the hidden representation.

In some examples, the encoder further includes a convolutional subsampling layer followed by the stack of multi-head attention blocks that include a plurality of unmodified conformer blocks each including a multi-head self-attention layer and at least one modified conformer block that replaces the multi-head self-attention layer of a corresponding unmodified conformer with a combined pooling and multi-head self-attention layer that applies a pooling operation to reduce an effective length of an output by a factor corresponding to a query stride value s by pooling over non-overlapping blocks of length equal to s. Here, the pooling operation applied by the combined pooling and multi-head self-attention layer may be only applied to a query of a multi-head self-attention operation without pooling a key and value of the multi-head self-attention operation. In these examples, each unmodified conformer block may include a first half feed-forward layer, a second half feed-forward layer, with a convolution layer and the multi-head self-attention layer disposed between the first and second half feed-forward layers, and concatenation operators and the at least one modified conformer block includes the first half feed-forward layer, the second half feed-forward layer, with the convolution layer and the combined pooling and multi-head self-attention layer disposed between the first and second half feed-forward layers, and concatenation operators. A last multi-head attention block in the stack of multi-head attention blocks may include one of the at least one modified conformer blocks. The at least one modified conformer block may include two modified conformer blocks each having a different respective stride value. In these examples, the at least one modified conformer block may include at least two modified conformer blocks each having a same stride value. In some implementations, a number of the output tokens in the sequence of output tokens decoded by the decoder is greater than the number of encoder output frames.

One aspect of the disclosure provides a computer-implemented method that when executed on data processing hardware causes the data processing hardware to perform operations of reducing the number of encoder output frames. The operations include receiving a sequence of encoder input frames as input to an end-to-end model. The operations also include generating a sequence of encoder output frames based on the sequence of encoder input frames using an encoder of the end-to-end model. The encoder includes a stack of multi-head attention blocks arranged to apply an encoder reduction ratio on the sequence of encoder input frames. Here, a number of encoder output frames generated as output from the encoder is reduced from a number of the encoder input frames received as input to the encoder by a factor proportional to the encoder reduction ratio applied by the stack of multi-head attention blocks. The operations also include decoding the sequence of encoder output frames into a sequence of output tokens using a decoder of the end-to-end model.

Implementations of the disclosure may include one or more of the following optional features. In some implementations, the end-to-end model includes an end-to-end automated speech recognition (ASR) model, the encoder includes an audio encoder, the encoder input frames includes acoustic feature frames characterizing a spoken utterance, and the sequence of output tokens characterize a transcription of the utterance. Here, the output tokens may include wordpieces. In these implementations, the output tokens may include graphemes, phonemes, or words.

In some examples, the operations further include, at each of a plurality of output steps: generating, by a prediction network of the decoder, a hidden representation based on a sequence of previous non-blank output symbols output by a final softmax layer; and generating, by a joint network of the decoder, a probability distribution over possible output tokens based on the hidden representation generated by the prediction network at each of the plurality of output steps and each encoder output frame in the sequence of encoder output frames generated by the encoder. In these examples, the sequence of previous non-blank symbols received as input at the prediction network may include a sequence of N previous non-blank symbols output by the final softmax layer and generating the hidden representation includes generating a respective embedding for each non-blank symbol of the sequence of N previous non-blank symbols and generating an average embedding by averaging the respective embeddings with the average embedding including the hidden representation.

In some implementations, the encoder further includes a convolutional subsampling layer followed by the stack of multi-head attention blocks that includes a plurality of unmodified conformer blocks each including a multi-head self-attention layer and at least one modified conformer block that replaces the multi-head self-attention layer of a corresponding unmodified conformer with a combined pooling and multi-head self-attention layer that applies a pooling operation to reduce an effective length of an output by a factor corresponding to a query stride value s by pooling over non-overlapping blocks of length equal to s. Here, the pooling operation applied by the combined pooling and multi-head self-attention layer may be only applied to a query of a multi-head self-attention operation without pooling a key and value of the multi-head self-attention operation. In these implementations, each unmodified conformer block may include a first half feed-forward layer, a second half feed-forward layer, with a convolution layer and the multi-head self-attention layer disposed between the first and second half feed-forward layers, and concatenation operators and the at least one modified conformer block includes the first half feed-forward layer, the second half feed-forward layer, with the convolution layer and the combined pooling and multi-head self-attention layer disposed between the first and second half feed-forward layers, and concatenation operators. A last multi-head attention block in the stack of multi-head attention blocks may include one of the at least one modified conformer blocks. At least one modified conformer block may include two modified conformer blocks each having a different respective stride value. In these implementations, the at least one modified conformer block may include at least two modified conformer blocks each having a same stride value. In some implementations, a number of the output tokens in the sequence of output tokens decoded by the decoder is greater than the number of encoder output frames.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example speech recognition model that includes an encoder and a decoder.

FIG. 3 is a schematic view of an example encoder that includes unmodified conformer blocks and modified conformer blocks.

FIG. 4 is a schematic view of an example unmodified conformer block.

FIG. 5 is a schematic view of an example modified conformer block.

FIG. 6 is a flowchart of an example arrangement of operations for a computer-implemented method of reducing the number of encoder output frames.

FIG. 7 is a schematic view of an example computing device that may be used to implement the systems and methods described herein.

Like reference symbols in the various drawings indicate like elements.

### DETAILED DESCRIPTION

End-to-end automatic speech recognition (ASR) models have become increasingly popular in recent years. As performance of the ASR models has increased, so has the number of parameters of the ASR models with some ASR models having billions of parameters. The larger ASR models, coupled with full-sequence processing of input audio, has enabled significant improvements in word error rates (WER) at a cost of much higher computational latency. High-latency processing may be acceptable in some speech recognition tasks (e.g., offline video captioning) while other speech recognition tasks (e.g., recognizing short voice search queries) require low-latency processing. As such, speech recognition tasks that require low-latency processing cannot benefit from the large, full-sequence ASR models unless the computational latency associated with operating these models significantly reduces.

To that end, implementations herein are directed towards an end-to-end model and a method of operating the end-to-end model that reduces the number of encoder output frames. The end-to-end model includes an encoder and a decoder. The encoder includes a stack of multi-head attention blocks arranged to apply an encoder reduction ratio on a sequence of encoder input frames. The encoder is configured to receive, as input, the sequence of encoder input frames and generate, as output, a sequence of output frames based on the sequence of encoder input frames. Notably, the number of the encoder output frames generated as output from the encoder is reduced from a number of the encoder input frames received as input to the encoder by a factor proportional to the encoder reduction ratio applied by the stack of multi-head attention blocks. The decoder is configured to decode the sequence of encoder output frames into a sequence of output tokens. Moreover, a number of the output tokens in the sequence of output tokens decoded by the decoder is greater than the number of encoder output frames.

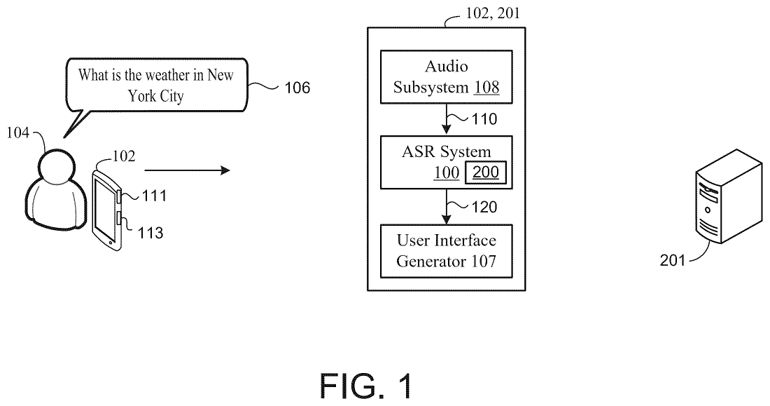

FIG. 1 illustrates an automated speech recognition (ASR) system 100 implementing an end-to-end model 200 that resides on a user device 102 of a user 104 and/or on a remote computing device 201 (e.g., one or more servers of a distributed system executing in a cloud-computing environment) in communication with the user device 102. The end-to-end model 200 may include an end-to-end ASR model. As such, the end-to-end model 200 may interchangeably be referred to as “the ASR model 200” herein. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames (i.e., sequence of encoder input frames) 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

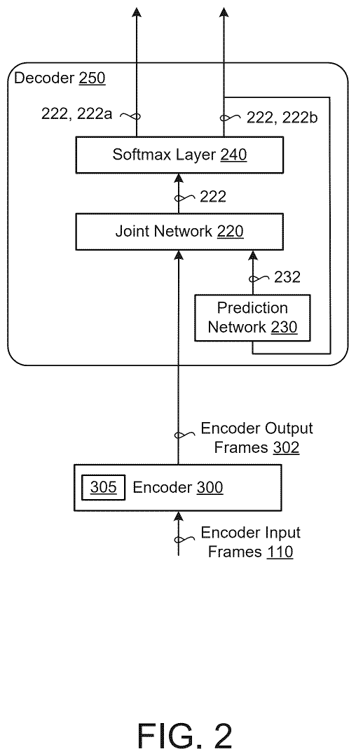

Referring now to FIG. 2, in some implementations, the ASR model 200 includes an encoder 300 and a decoder 250. The ASR model 200 may include any one of a hybrid autoregressive transducer (HAT) architecture, a recurrent neural network transducer architecture (RNN-T), or a connectionist temporal classification (CTC) architecture. The encoder 300 is configured to receive, as input, the sequence of encoder input frames 110 which may include acoustic feature frames characterizing a spoken utterance 106 (FIG. 1) and generate, as output, a sequence of encoder output frames 302 based on the sequence of encoder input frames 110. The sequence of encoder input frames 110 may be represented by x=(x₁, . . . , x_{T′}), where xₜ∈ [symbol] and T′ represents a number of the sequence of encoder input frames 110. The sequence of encoder output frames 302 may be represented by h=(h₁, . . . , h_{T}), where hₜ∈ [symbol] and T represents a number of the sequence of encoder output frames 302. The ratio of the number of the sequence of encoder input frames 110 to the number of the sequence of encoder output frames 302 may be referred to as an encoder reduction ratio 305 represented by

$${r}_{enc} = \frac{{T}^{′}}{T}$$

and the effective amount of speech corresponding to each encoder output frame 302 is referred to as an encoder output duration (f_{enc}).

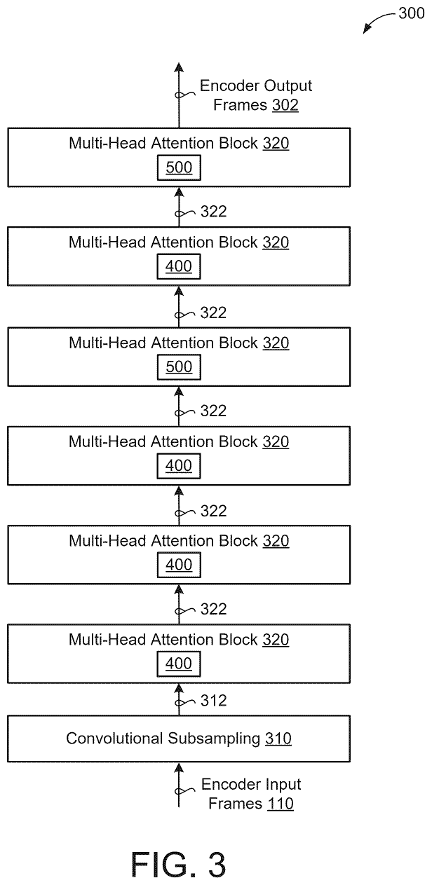

The encoder 300 may include an audio encoder. In some configurations, the encoder 300 generates a corresponding output frame 302 at each of a plurality of output steps. As discussed in greater detail with reference to FIG. 3, the encoder 300 includes a stack of multi-head attention blocks 320 arranged to apply an encoder reduction ratio 305 on the sequence of encoder input frames 110. Moreover, the number of the encoder output frames 302 generated as output from the encoder 300 is reduced from the number of encoder of the encoder input frames 110 received as input to the encoder 300 by a factor proportional to the encoder reduction ratio 305 applied by the stack of multi-head attention blocks 320 (FIG. 3).

In some implementations, the decoder 250 includes a joint network 220, a prediction network 230, and final Softmax layer 240. As will become apparent, the final Softmax layer 240 is configured to generate a sequence of output tokens 242 at each of the plurality of output steps as output from the decoder 250 The sequence of output tokens 242 may be represented by y=(y₁, . . . , y_{U}), where U represents a number of the output tokens 242. The sequence of output tokens 242 may include blank symbols (i.e., blank tokens) 242, 242a and/or non-blank symbols (i.e., non-blank tokens) 242, 242b. At each of the plurality of output steps, the prediction network 230 is configured to receive a sequence of previous non-blank symbols 242b output by the final softmax layer 240 and generate a hidden representation 232 based on the sequence of previous non-blank symbols 224b. The sequence of previous non-blank symbols 242b may include a sequence of N previous non-blanks symbols 242b output by the final Softmax layer 240. Here, the prediction network 230 may be configured to generate the hidden representation 232 by generating a respective embedding for each non-blank symbol 242b of the sequence of N previous non-blank symbols 242b and generating an average embedding by averaging the respective embeddings such that the average embedding includes or represents the hidden representation 232. Thus, the hidden representation 232 summarizes the sequence of N previous non-blank symbols 242b output by the final Softmax layer 240 whereby N is configurable such that the prediction network 230 may provide more or less context to the joint network 220. The prediction network 230 may include a V² prediction network that concatenates and projects the last two non-blank symbols 242 output by the final softmax layer 240. Alternatively, the prediction network 230 may include a long short term memory (LSTM) prediction network with two layers each with 2048 cells per layer.

The joint network 220 is configured to receive, as input, the hidden representation 232 generated by the prediction network 230 at each of the plurality of output steps and the encoder output frame 302 generated by the encoder 300 at each of the plurality of output steps and generate a probability distribution 222 over possible output tokens. The joint network 220 may use a standard tanh combination after linearly projecting the encoder and prediction network output to 640 dimensions. In some implementations, the probability distribution 222 over possible output tokens includes a first probability distribution over non-blank symbols P(y|hₜ, yᵤ₋₁, . . . , y₁) and a second probability distribution over blank symbols P( [symbol] b [symbol] |hₜ, yᵤ₋₁, . . . , y₁).

In some examples, the possible output tokens correspond to possible speech recognition hypotheses. Here, the “possible speech recognition hypotheses” correspond to a set of output labels/symbols (also referred to as “speech units”) each representing a grapheme (symbol/character), wordpiece in a specified natural language, or a blank symbol. For example, when the natural language is English, the set output labels may include twenty-seven (27) symbols, e.g., one label for each of the 26-letters in the English alphabet and one label designating a blank or space. Accordingly, the joint network 220 may output a set of values indicative of the likelihood of occurrence of each of a predetermined set of output labels. The set of values can be a vector (e.g., a one-hot vector) and can indicate a probability distribution over the set of output labels. In some scenarios, the output labels are graphemes (e.g., individual characters, and potentially punctuation and other symbols), but the set of output labels is not so limited. For example, the set of output labels can include wordpieces and/or entire words, in addition to or instead of graphemes. The output labels could also be other types of speech units, such as phonemes or sub-phonemes. The probability distribution 222 may include a posterior probability for each of the different output labels. Thus, if there are 100 different output labels representing different graphemes or other symbols, the output of the joint network 220 can include 100 different probability values, one for each output label. To that end, the probability distribution 222 over possible output tokens can then be used to select and assign scores to candidate orthographic elements (e.g., graphemes, wordpieces, and/or words) in a beam search process by the final Softmax layer 240. For example, the final Softmax layer 240 may select the N-best possible output tokens having the highest probabilities as output for the sequence of output tokens 242.

The final Softmax layer 240 may employ any technique to select the possible output label/symbol with the highest probability in the probability distribution 222 as the next output token 242 predicted by the ASR model 200 at the corresponding output step. In this manner, the ASR model 200 does not make a conditional independence assumption, rather the prediction of each symbol is conditioned not only on the acoustics but also on the sequence of output tokens 242 output so far. The sequence of output tokens 242 may include blank output tokens 242a and/or non-blank output tokens 242b. The output tokens 242 may include any combination of wordpieces, graphemes, phonemes, or words. Thus, the sequence of output tokens 242 may characterize the transcription 120 of the utterance 106 (FIG. 1). The ASR model 200 may not assume an output token 242 is independent of future acoustic frames 110, which allows the ASR model 200 to be employed in a streaming fashion, non-streaming fashion, or some combination thereof. That is, the number of output tokens 242 produced at each output step may be different as other output steps or the same as the other output steps. Notably, the number of the output tokens 242 in the sequence of output tokens 242 decoded by the decoder 250 (e.g., output by the decoder 250) is greater than the number of encoder output frames 302 provided as input to the decoder 250.

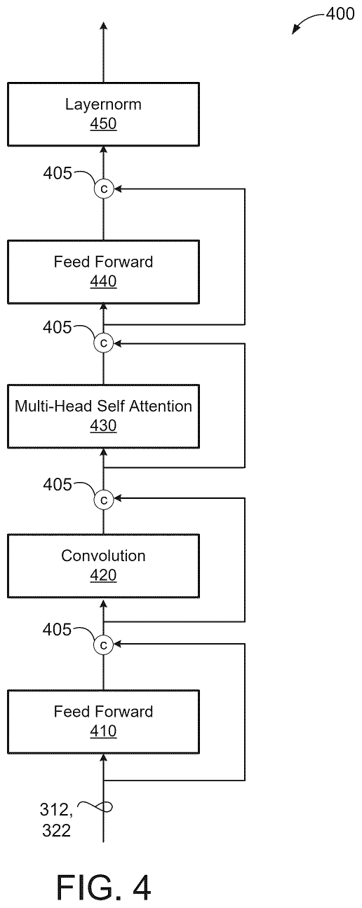

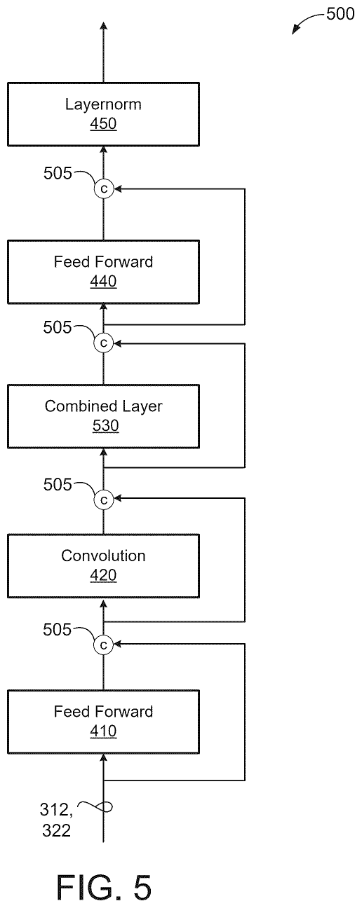

Referring now to FIG. 3, in some implementations, the encoder 300 includes a convolutional subsampling layer 310 followed by the stack of multi-head attention blocks 320. In the example shown, the stack of multi-head attention blocks 320 includes six (6) multi-head attention blocks 320 by way of example only. That is, the stack of multi-head attention blocks 320 may include any number of multi-head attention blocks 320. The stack of multi-head attention blocks 320 include a plurality of unmodified conformer blocks 400 each including a multi-head self-attention layer 430 (FIG. 4). Moreover, the stack of multi-head attention blocks 320 includes at least one modified conformer block 500. Each modified conformer block 500 of the at least one modified conformer block 500 replaces the multi-head self-attention layer 430 of a corresponding unmodified conformer block 400 with a combined pooling and multi-head self-attention layer 530 (FIG. 5) that applies a pooling operation to reduce an effective length of an output by a factor corresponding to a query stride value s by pooling over non-overlapping blocks of length equal to s.

In the example shown, the first three multi-head attention blocks 320 and a fifth multi-head attention block 320 includes the unmodified conformer block 400 while the fourth and sixth multi-head attention blocks 320 include the modified conformer block 500 by way of example only. In this example, a respective modified conformer block 500 replaces corresponding unmodified conformer blocks 400 of the fourth and sixth multi-head attention blocks 320. The stack of multi-head attention blocks 320 may include any number of multi-head attention blocks 320 with the stack of multi-head attention blocks 320 including any combination of unmodified conformer blocks 400 and modified conformer blocks 500. In some configuration, each modified conformer block 500 of the at least one modified conformer block 500 have a different respective stride value(s). In other configurations, each modified conformer block 500 of the at least one modified conformer block 500 have a same respective stride value(s). In yet other configurations, the at least one modified conformer block 500 includes a plurality of modified conformer blocks 500 with some modified conformer blocks 500 having the same respective stride value(s) and other modified conformer blocks 500 having a different respective stride value(s).

FIG. 4 shows an example unmodified conformer block 400 of one of the multi-head attention blocks 320 (FIG. 3). The unmodified conformer block 400 includes a first half feed-forward layer 410, a second half feed-forward layer 440, with a convolutional layer 420 and the multi-head self-attention layer 430 disposed between the first and second half feed-forward layers 410, 440, and concatenation operators 405. Optionally, the unmodified conformer block 400 may include a layernorm module 450. The first half feed-forward layer 410 processes an input (e.g., a subsampled output 312 or intermediate output 322) by projecting the input into a larger dimension, followed by a non-linear activation, and then another linear layer to project the input back to the original dimension. Subsequently, the convolution layer 420 subsamples the input (e.g., the subsampled output 312 or the intermediate output 322) concatenated with the output of the first half feed-forward layer 410. That is, the convolution layer 420 aggregates information from neighboring context to capture relative offset-based local interactions. The multi-head self-attention layer 430 may include a conformer or transformer layer. The multi-head self-attention layer 430 receives the output of the convolution layer 420 concatenated with the output of the first half feed-forward layer 410. Intuitively, the role of the multi-head self-attention layer 430 is to summarize noise context separately for each input frame that is to be enhanced. The multi-head self-attention layer 430 looks back L previous frames and converts an output into a fixed-length vector thereby capturing more global patterns. The multi-head self-attention layer 430 maintains a large number of internal states. A significant portion of these internal states correspond to the key and value tensors of self-attention causing an increase in latency due to repeatedly loading each of these internal states (e.g., quadratic computational cost).

Thereafter, the second half feed-forward layer 440 receives a concatenation of the output of the multi-head self-attention layer 430 and the output of the convolution layer 420. The layernorm module 450 processes a concatenation of the output from the second half feed-forward layer 440 and the output of the multi-head self-attention layer 430. That is, the unmodified conformer block 400 transforms each input feature in a sequence of input features, using modulation features m, to generate, at each output step, an output 302, 322 for a corresponding input feature in the sequence of input features.

The output of the unmodified conformer block 400 that corresponds to any multi-head attention block 320 that is not the last multi-head attention block 320 in the stack of multi-head attention block 320 includes the intermediate output 322 that is fed to the next multi-head attention block 320. On the other hand, the output of the unmodified conformer block 400 that corresponds to the last multi-head attention block 320 in the stack of multi-head attention block 320 includes the encoder output frame 302 that is fed to the decoder 250 (FIG. 2).

The unmodified conformer block 400 may generate each output 302, 322 according to:

$${v}_{i}^{′} = {v}_{i} + \frac{1}{2} {FFN}_{1} ( {v}_{i} ) + Conv ( {v}_{i} + \frac{1}{2} \frac{1}{2} {FFN}_{1} ( {v}_{i} ) ) \qquad ( 1 )$$

$${v}_{i}^{″} = {v}_{i}^{′} + MHSA ( Q = {v}_{i}^{′} , KV = {v}_{i}^{′} ) \qquad ( 2 )$$

$${v}_{0} = LayerNorm ( {v}_{i}^{″} + \frac{1}{2} {FFN}_{2} ( {v}_{i}^{″} ) ) \qquad ( 3 )$$

### In Equation 1,

$${v}_{i}^{′}$$

represents the output of the convolution layer 420, vᵢ represents the input (e.g., the subsampled output 312 or the intermediate output 322), and FFN₁ represents the first half feed-forward network 410. In Equation 2,

$${v}_{i}^{″}$$

represents the output of the multi-head self-attention layer 430, MHSA represents the self-attention operation applied by the multi-head self-attention layer 430, Q and KV represent query and key value pairs, respectively, applied by the multi-head self-attention layer 430. In Equation 3, vₒ represents the output of the layernorm module 450, LayerNorm represents the operation applied by the layernorm module 450, and FFN₂ represents the second half feed-forward network 440. Notably, using the unmodified conformer 400, the number of encoder output frames 302 (vₒ) output by the unmodified conformer 400 is exactly the same as the number encoder input frames 110 (vᵢ) received by the unmodified conformer 400.

FIG. 5 shows an example modified conformer block 500 of one of the multi-head attention blocks 320 (FIG. 3). The modified conformer block 500 includes the first half feed-forward layer 410, the second half feed-forward layer 440, with the convolutional layer 420 and the combined pooling and multi-head self-attention layer 530 disposed between the first and second half feed-forward layers 410, 440, and concatenation operators 505. Optionally, the modified conformer block 500 may include the layernorm module 450. Thus, the modified conformer block 500 may include the same structure or architecture as the unmodified conformer block 400 (FIG. 4) except for the combined pooling and multi-head self-attention layer 530 which replaces the multi-head self-attention layer 430 (FIG. 4). The first half feed-forward layer 410 processes an input (e.g., a subsampled output 312 or intermediate output 322) by projecting the input into a larger dimension, followed by a non-linear activation, and then another linear layer to project the input back to the original dimension. Subsequently, the convolution layer 420 subsamples the input (e.g., the subsampled output 312 or the intermediate output 322) concatenated with the output of the first half feed-forward layer 410. That is, the convolution layer 420 aggregates information from neighboring context to capture relative offset-based local interactions. The combined pooling and multi-head self-attention layer 530 may include a conformer or transformer layer. The combined pooling and multi-head self-attention layer 530 receives the output of the convolution layer 420 concatenated with the output of the first half feed-forward layer 410. Intuitively, the role of the combined pooling and multi-head self-attention layer 530 may be to summarize noise context separately for each input frame that is to be enhanced.

Thereafter, the second half feed-forward layer 440 receives a concatenation of the output of the combined pooling and multi-head self-attention layer 530 and the output of the convolution layer 420. The layernorm module 450 processes a concatenation of the output from the second half feed-forward layer 440 and the output of the combined pooling and multi-head self-attention layer 530. That is, the modified conformer block 500 transforms each input feature in a sequence of input features, using modulation features m, to generate, at each output step, an output 302, 322 for a corresponding input feature in the sequence of input features. The output of the modified conformer block 500 that corresponds to any multi-head attention block 320 that is not the last multi-head attention block 320 in the stack of multi-head attention block 320 includes the intermediate output 322 that is fed to the next multi-head attention block 320. On the other hand, the output of the modified conformer block 500 that corresponds to the last multi-head attention block 320 in the stack of multi-head attention block 320 includes the encoder output frame 302 that is fed to the decoder 250 (FIG. 2).

The modified conformer block 500 may generate each output 302, 322 in a similar manner as the unmodified conformer block 400 (FIG. 4) except that the modified conformer block 500 replaces the operations of Equation 2 with a combination of pooling and multi-head self-attention according to:

$$= AvgPooling ( {v}_{i}^{′} , query stride = s ) \qquad ( 4 )$$

$$= MaxPooling ( {v}_{i}^{′} , query stride = s ) \qquad ( 5 )$$

$$= + MHSA ( Q = , KV = {v}_{i}^{′} ) \qquad ( 6 )$$

Thus, the unmodified conformer block 400 (FIG. 4) generates each output 302, 322 according to Equations 1-3, while the modified conformer block 500 generates each output 302, 322 according to Equations 1 and 3-6. In particular, the modified conformer block 500 uses Equations 4-6 in place of Equation 2 when compared to the unmodified conformer 400. In Equation 4, [symbol] represents the average pooling output of the combined pooling and multi-head self-attention layer 530, AvgPooling represents the average pooling operation,

$${v}_{i}^{′}$$

represents the output of the convolution layer 420, and s represents the query stride applied by the combined pooling and multi-head self-attention layer 530. In Equation 5, [symbol] represents the max pooling output of the combined pooling and multi-head self-attention layer 530, MaxPooling represents the max pooling operation,

$${v}_{i}^{′}$$

represents the output of the convolution layer 420, and s represents the query stride applied by the combined pooling and multi-head self-attention layer 530. In Equation 6,

$${v}_{i}^{″}$$

represents the output of the combined pooling and multi-head self-attention layer 530, MHSA represents the self-attention operation applied by the combined pooling and multi-head self-attention layer 530, Q and KV represent query and key value pairs, respectively, applied by the combined pooling and multi-head self-attention layer 530.

As such, the combined pooling and multi-head self-attention layer 530 applies a pooling operation (e.g., average pooling and/or maximum pooling) to reduce an effective length of the output of the combined pooling and multi-head self-attention layer 530, and thus, the sequence of encoder output frames 302 output by the encoder 300. Average pooling includes extracting an average value from the input while maximum pooling includes extracting a maximum value from the input. To that end, the pooling operation reduces the effective length of the output of the combined pooling and multi-head self-attention layer 530 by a factor corresponding to a query stride value s by pooling over non-overlapping blocks (e.g., non-overlapping input features) of length equal to the query stride value s. Moreover, the pooling operation applied by the combined pooling and multi-head self-attention operation applies pooling without pooling a key and value (e.g., key value pairs KV) of the multi-head self-attention operation. Notably, the pooling operation applied by the combined pooling and multi-head self-attention layer 530 reduces the effective length of [symbol] and [symbol] , and thus the number of encoder output frames 302, by a factor of s:

$$\vert {v}_{o} \vert = \frac{1}{s} \vert {v}_{i} \vert .$$

Here, the factor corresponds to a query stride value s by pooling over non-overlapping blocks of length equal to the query stride value s. Thus, with M number of modified conformer blocks 500, the total encoder reduction ratio 305 corresponds to

$${r}_{enc} = {\prod }_{i = 1}^{M} {s}_{i} .$$

Moreover, each modified conformer block 500 may include the same or different query stride value s as other modified conformer blocks 500. Here, the query stride value s refers to the number of key value pairs specified by each query. Put another way, the query value s represents a number of input frames processed during each output step.

Referring back to FIG. 3, the convolutional subsampling layer 310 receives the sequence of encoder input frames 110 and generates a corresponding subsampled output 312. That is, the convolutional subsampling layer 310 may increase the output duration of the sequence of encoder input frames 110 to a predetermined output duration, for example, 40 milliseconds (ms). Thereafter, an initial multi-head attention block 320 in the stack of multi-head attention block 320 receives the corresponding subsampled output 312 and generates a corresponding intermediate output 322 which transmits to the next multi-head attention block 320 in the stack of multi-head attention blocks 320. The next multi-head attention block 320 processes the intermediate output 322 from a subsequent multi-head attention block 320 and generates another intermediate output 322 which transmits to the next multi-head attention block 320 in the stack of multi-head attention blocks 320. The final multi-head attention block 320 in the stack of multi-head attention blocks 320 receives the intermediate output 322 from the subsequent multi-head attention block 320 and generates the encoder output frames 302 as output from the encoder 300 which transmits to the decoder 250 (FIG. 2). Thus, for an encoder 300 with a 20 ms encoder output duration (f_{enc}) that operates on 10 ms input feautres (xₜ), the encoder reduction ratio (r_{enc}) is equal to two (2).

Since the overall cost of decoding encoder output frames 302 in end-to-end models 200 is proportional to the maximum number of encoder output frames 302 (Tₘₐₓ) and the maximum number of non-blank output symbols 242b (Uₘₐₓ) produced by the end-to-end model 200 the computational latency increases as Tₘₐₓ and Uₘₐₓ increase. Here, computational latency refers to the time required to process the input audio and output a corresponding transcription 120 which is different from user-perceived latency which also includes additional delays such as detecting the end of the utterance in order to close a microphone. Thus, by reducing the number of encoder output frames 302, the end-to-end model 200 enables large reductions in computational latency while maintaining WER. Moreover, the encoder reduction ratio 305 is configurable such that a user may balance the tradeoff between WER and computational latency.

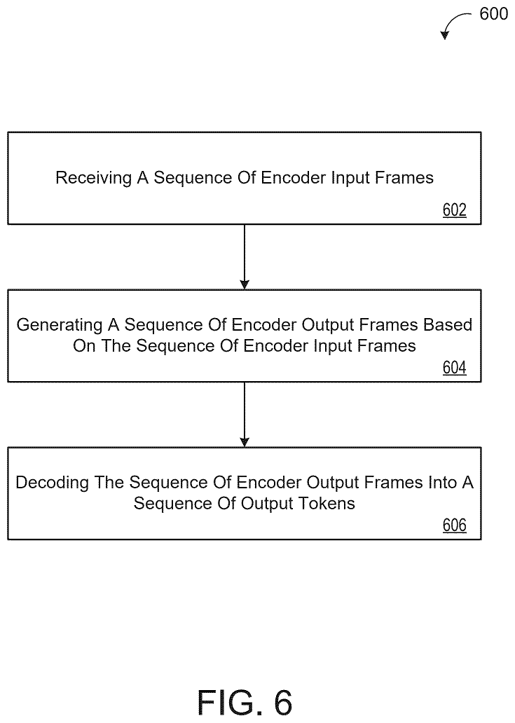

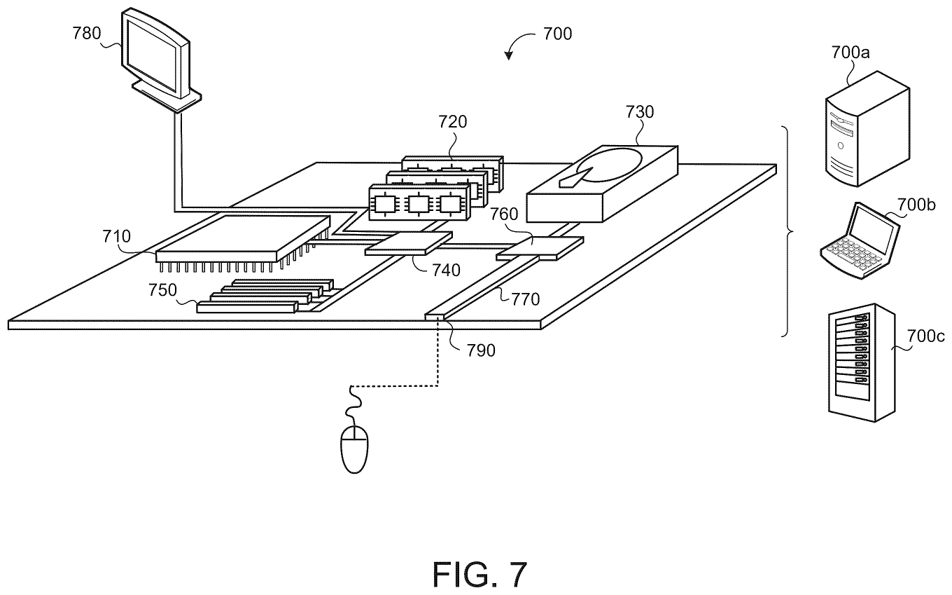

FIG. 6 is a flowchart of an example arrangement of operations for a computer-implemented method 600 of reducing the number of encoder output frames. The method 600 may execute on data processing hardware 710 (FIG. 7) using instructions stored on memory hardware 720 (FIG. 7). The data processing hardware 710 and the memory hardware 720 may reside on the user device 102 or the remote computing device 201 of FIG. 1 each corresponding to a computing device 700 (FIG. 7).

At operation 602, the method 600 includes receiving a sequence of encoder input frames 110 as input to an end-to-end model 200. At operation 604, the method 600 includes generating a sequence of encoder output frames 302 based on the sequence of encoder input frames 110 using an encoder 300 of the end-to-end model 200. The encoder 300 includes a stack of multi-head attention blocks 320 arranged to apply an encoder reduction ratio 305 on the sequence of encoder input frames 110. A number of encoder output frames 302 generated as output from the encoder 300 is reduced from a number of the encoder input frames 110 received as input to the encoder 300 by a factor proportional to the encoder reduction ratio 305 applied by the stack of multi-head attention blocks 320. At operation 606, the method 600 includes decoding the sequence of encoder output frames 302 into a sequence of output tokens 242.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system)

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. An end-to-end model comprising:
an encoder comprising a stack of multi-head attention blocks arranged to apply an encoder reduction ratio on encoder input frames, the encoder configured to:
receive, as input, a sequence of encoder input frames; and
generate, as output, a sequence of encoder output frames, wherein a number of the encoder output frames generated as output from the encoder is reduced from a number of the encoder input frames received as input to the encoder by a factor proportional to the encoder reduction ratio applied by the stack of multi-head attention blocks; and
a decoder configured to decode the sequence of encoder output frames into a sequence of output tokens.

2. The end-to-end model of claim 1, wherein:
the end-to-end model comprises an end-to-end automated speech recognition (ASR) model;
the encoder comprises an audio encoder;
the encoder input frames comprise acoustic feature frames characterizing a spoken utterance; and
the sequence of output tokens characterize a transcription of the utterance.

3. The end-to-end model of claim 1, wherein the output tokens comprise wordpieces.

4. The end-to-end model of claim 1, wherein the output tokens comprise graphemes, phonemes, or words.

5. The end-to-end model of claim 1, wherein the decoder comprises:
a prediction network configured to, at each of a plurality of output steps:
receive, as input, a sequence of previous non-blank symbols output by a final softmax layer; and
generate a hidden representation; and
a joint network configured to:
receive, as input, the hidden representation generated by the prediction network at each of the plurality of output steps and each encoder output frame in the sequence of encoder output frames generated by the encoder; and
generate, at each of the plurality of output steps, a probability distribution over possible output tokens.

6. The end-to-end model of claim 5, wherein, at each of the plurality of output steps:
the sequence of previous non-blank symbols received as input at the prediction network comprises a sequence of N previous non-blank symbols output by the final softmax layer; and
the prediction network is configured to generate the hidden representation by:
for each non-blank symbol of the sequence of N previous non-blank symbols, generating a respective embedding; and
generating an average embedding by averaging the respective embeddings, the average embedding comprising the hidden representation.

7. The end-to-end model of claim 1, wherein:
the encoder further comprises a convolutional subsampling layer followed by the stack of multi-head attention blocks; and
the stack of multi-head attention blocks comprises:
a plurality of unmodified conformer blocks each comprising a multi-head self-attention layer; and
at least one modified conformer block that replaces the multi-head self-attention layer of a corresponding unmodified conformer block with a combined pooling and multi-head self-attention layer that applies a pooling operation to reduce an effective length of an output by a factor corresponding to a query stride value s by pooling over non-overlapping blocks of length equal to s.

8. The end-to-end model of claim 7, wherein the pooling operation applied by the combined pooling and multi-head self-attention layer is only applied to a query of a multi-head self-attention operation without pooling a key and value of the multi-head self-attention operation.

9. The end-to-end model of claim 7, wherein:
each unmodified conformer block comprises a first half feed-forward layer, a second half feed-forward layer, with a convolution layer and the multi-head self-attention layer disposed between the first and second half feed-forward layers, and concatenation operators; and
the at least one modified conformer block comprises the first half feed-forward layer, the second half feed-forward layer, with the convolution layer and the combined pooling and multi-head self-attention layer disposed between the first and second half feed-forward layers, and concatenation operators.

10. The end-to-end model of claim 7, wherein a last multi-head attention block in the stack of multi-head attention blocks includes one of the at least one modified conformer blocks.

11. The end-to-end model of claim 7, wherein the at least one modified conformer block comprises two modified conformer blocks each having a different respective stride value.

12. The end-to-end model of claim 7, wherein the at least one modified conformer block comprises at least two modified conformer blocks each having a same stride value.

13. The end-to-end model of claim 1, wherein a number of the output tokens in the sequence of output tokens decoded by the decoder is greater than the number of encoder output frames.

14. A computer-implemented method executed on data processing hardware that causes the data processing hardware to perform operations comprising:
receiving, as input to an end-to-end model, a sequence of encoder input frames;
generating, using an encoder of the end-to-end model, a sequence of encoder output frames based on the sequence of encoder input frames, the encoder comprising a stack of multi-head attention blocks arranged to apply an encoder reduction ratio on the sequence of encoder input frames, wherein a number of encoder output frames generated as output from the encoder is reduced from a number of the encoder input frames received as input to the encoder by a factor proportional to the encoder reduction ratio applied by the stack of multi-head attention blocks; and
decoding, using a decoder of the end-to-end model, the sequence of encoder output frames into a sequence of output tokens.

15. The computer-implemented method of claim 14, wherein:
the end-to-end model comprises an end-to-end automated speech recognition (ASR) model;
the encoder comprises an audio encoder;
the encoder input frames comprise acoustic feature frames characterizing a spoken utterance; and
the sequence of output tokens characterize a transcription of the utterance.

16. The computer-implemented method of claim 14, wherein the output tokens comprise wordpieces.

17. The computer-implemented method of claim 14, wherein the output tokens comprise graphemes, phonemes, or words.

18. The computer-implemented method of claim 14, wherein the operations further comprise, at each of a plurality of output steps:
generating, by a prediction network of the decoder, a hidden representation based on a sequence of previous non-blank output symbols output by a final softmax layer; and
generating, by a joint network of the decoder, a probability distribution over possible output tokens based on the hidden representation generated by the prediction network at each of the plurality of output steps and each encoder output frame in the sequence of encoder output frames generated by the encoder.

19. The computer-implemented method of claim 18, wherein:
the sequence of previous non-blank symbols received as input at the prediction network comprises a sequence of N previous non-blank symbols output by the final softmax layer; and
generating the hidden representation comprises:
for each non-blank symbol of the sequence of N previous non-blank symbols, generating a respective embedding; and
generating an average embedding by averaging the respective embeddings, the average embedding comprising the hidden representation.

20. The computer-implemented method of claim 14, wherein
the encoder further comprises a convolutional subsampling layer followed by the stack of multi-head attention blocks; and
the stack of multi-head attention blocks comprises:
a plurality of unmodified conformer blocks each comprising a multi-head self-attention layer; and
at least one modified conformer block that replaces the multi-head self-attention layer of a corresponding unmodified conformer with a combined pooling and multi-head self-attention layer that applies a pooling operation to reduce an effective length of an output by a factor corresponding to a query stride value s by pooling over non-overlapping blocks of length equal to s.

21. The computer-implemented method of claim 20, wherein the pooling operation applied by the combined pooling and multi-head self-attention layer is only applied to a query of a multi-head self-attention operation without pooling a key and value of the multi-head self-attention operation.

22. The computer-implemented method of claim 20, wherein:
each unmodified conformer block comprises a first half feed-forward layer, a second half feed-forward layer, with a convolution layer and the multi-head self-attention layer disposed between the first and second half feed-forward layers, and concatenation operators; and
the at least one modified conformer block comprises the first half feed-forward layer, the second half feed-forward layer, with the convolution layer and the combined pooling and multi-head self-attention layer disposed between the first and second half feed-forward layers, and concatenation operators.

23. The computer-implemented method of claim 20, wherein a last multi-head attention block in the stack of multi-head attention blocks includes one of the at least one modified conformer blocks.

24. The computer-implemented method of claim 20, wherein the at least one modified conformer block comprises two modified conformer blocks each having a different respective stride value.

25. The computer-implemented method of claim 20, wherein the at least one modified conformer block comprises at least two modified conformer blocks each having a same stride value.

26. The computer-implemented method of claim 14, wherein a number of the output tokens in the sequence of output tokens decoded by the decoder is greater than the number of encoder output frames.
